(19) United States
(12) Patent Application Publication
(10) Pub. No.: US 2025/0382408 A1
(43) Pub. Date: Dec. 18, 2025

(54) EPOXY-TERMINATED ISOCYANATE PREPOLYMERS, AND PROCESS FOR THE PREPARATION THEREOF

(71) Applicant: BASF SE, Ludwigshafen am Rhein (DE)

(72) Inventors: Julian KLEEMANN, Lemfoerde (DE); Hans-Josef THOMAS, Korschenbroich (DE); Martin LINNENBRINK, Lemfoerde (DE); Jan Olaf SCHULENBURG, Wedemark (DE)

(73) Assignee: BASF SE, Ludwigshafen am Rhein (DE)

(21) Appl. No.: 18/877,345

(22) PCT Filed: Jun. 14, 2023
(86) PCT No.: PCT/EP2023/065894

§ 371 Date: Dec. 20, 2024

(30) Foreign Application Priority Data
Jun. 22, 2022 (EP) 22180419.8

(51) Int. Cl. C08G 18/12; C08G 18/24; C08G 18/48; C08G 18/58; C08G 18/69; C08K 5/3445; C09J 175/08

(52) U.S. Cl. CPC C08G 18/12; C08G 18/242; C08G 18/4854; C08G 18/58; C08G 18/69; C08K 5/3445; C09J 175/08; C08G 2170/00

(57) ABSTRACT

The present invention relates to processes for preparing an epoxy group-terminated impact modifier, by mixing one or more polyisocyanates (a) with two or more polyols (b), comprising at least one polyetherpolyol (b1) and at least one OH-terminated rubber (b2), at a molar ratio of isocyanate groups to OH groups of 10:1 to 1.5:1, and reacting the mixture to give an isocyanate-terminated prepolymer, and reacting the isocyanate-terminated prepolymer with a polyepoxide (c) in the presence of an ionic liquid to give the epoxy group-terminated impact modifier. Further, the present invention relates to an epoxy group-terminated impact modifier obtainable by a process of the invention, to the use of an epoxy group-terminated impact modifier in a one-component or two-component epoxy resin composition, preferably in a one-component or two-component epoxy resin adhesive, for increasing the impact resistance of the cured epoxy resin matrix, and to a one-component or two-component epoxy resin composition comprising at least one epoxy group-terminated impact modifier of the invention.

### DESCRIPTION

The present invention relates to processes for preparing an epoxy group-terminated impact modifier, by mixing one or more polyisocyanates (a) with two or more polyols (b), comprising at least one polyetherpolyol (b1) and at least one OH-terminated rubber (b2), at a molar ratio of isocyanate groups to OH groups of 10:1 to 1.5:1, and reacting the mixture to give an isocyanate-terminated prepolymer, and reacting the isocyanate-terminated prepolymer with a polyepoxide (c) in the presence of an ionic liquid to give the epoxy group-terminated impact modifier. Further, the present invention relates to an epoxy group-terminated impact modifier obtainable by a process of the invention, to the use of an epoxy group-terminated impact modifier in a one-component or two-component epoxy resin composition, preferably in a one-component or two-component epoxy resin adhesive, for increasing the impact resistance of the cured epoxy resin matrix, and to a one-component or two-component epoxy resin composition comprising at least one epoxy group-terminated impact modifier of the invention.

In the manufacture of vehicles and mounted parts or else of machinery and instruments, instead of or in combination with conventional joining processes such as screwing, riveting, punching or welding, the use of high-grade adhesives is becoming more and more frequent. This is giving rise to advantages and new opportunities in manufacturing, for example the manufacture of composite and hybrid materials, or else greater freedoms in the design of components. For use in vehicle production, the adhesives are required to show good adhesion on all substrates employed, especially on electrolytically galvanized, hot dip galvanized and subsequently phosphated steel sheets, oiled steel sheets, and also on various, possibly surface-treated aluminum alloys. These good adhesion properties must be retained particularly even after aging (climatic cycling, salt spray bath, etc.) without great detractions in quality. If the adhesives are used as bodyshell adhesives in automotive engineering, the resistance of these adhesives toward cleaning baths and deposition coating (known as washout resistance) is of great importance, so that operational reliability at the producer's premises can be guaranteed.

In the case of 1K [1-component] adhesives, the adhesives for the bodyshell are intended to cure under the customary baking conditions of ideally 30 min at 180° C. In the case of 2K [2-component] adhesives, the curing is intended to take place at room temperature in the course of several days to around 1 week, although an accelerated curing regime is also to be employable, such as, for example, 4 h at RT followed by 30 min at 60° C. or 85° C. Furthermore, however, they are also to be resistant up to about 220° C. Further requirements for a cured adhesive of this kind, or for the bond, are the assurance of operational reliability not only at high temperatures up to about 90° C. but also at low temperatures down to about −40° C. Given that these adhesives are structural adhesives and that these adhesives therefore bond structural parts, the utmost importance is attached to high strength, such as high peel strength and high lap shear strength, to reduced crack propagation, and to high impact resistance of the adhesive.

Conventional epoxy adhesives are indeed notable for high mechanical strength, in particular high tensile strength. In the event of abrupt stressing of the bond, however, classic epoxy adhesives are usually too brittle and are therefore far from being able to satisfy the requirements, especially on the part of the automotive industry, under crash conditions, where not only large tensile stresses but also peel stresses occur. Often particularly inadequate in these respects are the strengths at high, but in particular at low temperatures, for example below 20° C. or below 10° C.

From the literature there are two known methods for reducing the brittleness of epoxy adhesives and so increasing the impact resistance: Firstly, the objective can be achieved by the admixing of at least partly crosslinked compounds of high molecular mass, such as latices of core/shell polymers or other flexibilizing polymers and copolymers. A method of this kind is described for example in U.S. Pat. No. 5,290,857. Secondly, a certain increase in resistance can also be achieved by introduction of soft segments, by the corresponding modification of the epoxy components, for example. For instance, U.S. Pat. No. 4,952,645 describes epoxy resin compositions which have been flexibilized by reaction with carboxylic acids, especially dimeric or trimeric fatty acids, and also with carboxylic acid-terminated diols.

EP 0353190 relates to a flexibilizing component for epoxy resins, based on monophenol- or epoxy-terminated polymers. EP 1574537 A1 and EP 1602702 A1 describe epoxy resin adhesive compositions which comprise monophenol- or epoxy-terminated polymers as impact modifiers.

EP 2060592 describes thermosetting epoxy resin compositions, with one example specifying the production of an impact modifier from a mixture of a polyalkylene glycol and a hydroxyl-terminated polybutadiene and isophorone diisocyanate and cardanol as blocking agent.

EP 0383505 relates to a reactive hotmelt adhesive which comprises a urethane prepolymer formed from a polyisocyanate and a polyetherpolyol, and a thermoplastic elastomer, where the urethane prepolymer may be produced with additional use of hydroxy-terminated polybutadienes.

EP 1741734 relates to a heat-curable epoxy resin composition which comprises a solid epoxy resin and an impact modifier obtainable through the reaction of a monohydroxyl epoxy compound and an isocyanate-terminated polyurethane polymer; one example prepares the polyurethane polymer using a mixture of polyalkylene glycols and hydroxyl-terminated polybutadiene as the polyol.

WO2014/072515 relates to an epoxy group-terminated impact modifier which is obtained by producing a urethane prepolymer comprising isocyanate groups and reacting this prepolymer with epoxy resin which comprises an epoxy compound comprising primary or secondary hydroxyl group. The urethane prepolymer here may be produced using isophorone diisocyanate as the isocyanate component and, as the polyol component, a polyol mixture which comprise at least one polyetherpolyol and at least one OH-terminated rubber.

A disadvantage of the urethane-linked impact modifiers is reduced temperature stability. Further, the compatibility of the impact modifiers of the invention with the epoxy matrix is better, leading to better impact toughness properties.

U.S. Pat. No. 5,480,958 describes the reaction of NCO-terminated prepolymers with epoxides to give oxazolidone structural elements. In this case, potassium acetate is used as a catalyst for the reaction. The profile of properties of these impact modifiers, though, is still in need of improvement, particularly with regard to impact resistance, fracture resistance and fracture energy G_{1c}.

It was an object of the present invention, therefore, to provide an improved impact modifier which in epoxy resins, such as epoxy adhesives, leads to outstanding impact resistance in conjunction with high lap shear strength, peel strength, and reduced crack propagation. Further, an impact modifier of this kind ought as far as possible not to lower the glass transition temperature of the epoxy resin and not unduly increase the viscosity of the epoxy resin formulation, to preserve ease of processing.

The object of the present invention is achieved by an epoxy group-terminated impact modifier, preparable by a process of mixing one or more polyisocyanates (a) with two or more polyols (b), comprising at least one polyetherpolyol (b1) and at least one OH-terminated rubber (b2), at a molar ratio of isocyanate groups to OH groups of 10:1 to 1.5:1, and reacting the mixture to give an isocyanate-terminated prepolymer, and reacting the isocyanate-terminated prepolymer with a polyepoxide (c) in the presence of an ionic liquid to give the epoxy group-terminated impact modifier. Further, the present invention relates to such a process, to the use of an epoxy group-terminated impact modifier in a one-component or two-component epoxy resin composition, preferably in a one-component or two-component epoxy resin adhesive, for increasing the impact resistance of the cured epoxy resin matrix, and to a one-component or two-component epoxy resin composition comprising at least one epoxy group-terminated impact modifier of the invention.

To prepare the epoxy group-terminated impact modifier of the invention, in a first step, an isocyanate prepolymer is obtained from one or more polyisocyanates (a) with two or more polyols (b).

Isocyanates (a) which can be used here are all polyisocyanates known for the preparation of polyurethanes. These comprise the aliphatic, cycloaliphatic and aromatic divalent or polyvalent isocyanates known from the prior art and any desired mixtures thereof. Examples are diphenyl-methane 2,2′-, 2,4′- and 4,4′-diisocyanate, the mixtures of monomeric diphenylmethane diisocyanates and diphenylmethane diisocyanate homologs having a larger number of rings (polymeric MDI), isophorone diisocyanate (IPDI) or its oligomers, tolylene 2,4- or 2,6-diisocyanate (TDI) or mixtures of these, tetramethylene diisocyanate or its oligomers, hexamethylene diisocyanate (HDI) or its oligomers, naphthylene diisocyanate (NDI) or mixtures thereof. Further, it is also possible to use modified isocyanates, such as isocyanurate-, uretdione-, allophanate- or uretonimine-modified polyisocyanates. Further possible isocyanates are indicated for example in “Kunststoffhandbuch”, volume 7, “Polyurethane”, Carl Hanser Verlag, 3rd edition 1993, chapters 3.2 and 3.3.2.

Preferred for use as isocyanate (a) is isophorone diisocyanate (IPDI), optionally in a mixture with modified isophorone diisocyanate, and preferably isophorone diisocyanate, more particularly exclusively isophorone diisocyanate.

Polyols used are two or more polyols (b), comprising at least one polyetherpolyol (b1) and at least one OH-terminated rubber (b2).

Polyols used here may be all compounds known in polyurethane chemistry and having at least 2, preferably 2 to 8, isocyanate-reactive groups. They comprise polyetherols, polyesterols, polyamines, OH-terminated polymers, such as OH-terminated rubber, and compounds which are known as chain extenders and as crosslinking agents. Such compounds are described for example in “Kunststoffhandbuch”, volume 7, “Polyurethane”, Carl Hanser Verlag, 3rd edition 1993, chapters 3.1 and 3.4.3.

The polyetherols (b1) have preferably polyetherpolyol (b1) an OH number of 20 to 100 mg KOH/g, more preferably 35 to 80 mg KOH/g and more particularly 45 to 65 mg KOH/g, and a functionality of preferably 2 to 3, more particularly 2.

The polyetherols which can be used in accordance with the invention are prepared by known processes. For example, they can be prepared by anionic polymerization of alkylene oxides using alkali metal hydroxides, such as sodium or potassium hydroxide, or alkali metal alkoxides, such as sodium methoxide, sodium or potassium ethoxide or potassium isopropoxide, as catalysts and with addition of at least one starter molecule having preferably 2 to 3 reactive hydrogen atoms, or by cationic polymerization using Lewis acids, such as antimony pentachloride, boron fluoride etherate, etc., or bleaching earth as catalysts. Polyetherpolyols may likewise be prepared from one or more alkylene oxides having 2 to 4 carbon atoms in the alkylene radical by means of double metal cyanide catalysis. Tertiary amines can also be used as a catalyst: for example, triethylamine, tributylamine, trimethylamine, dimethylethanolamine, imidazole or dimethylcyclohexylamine.

Examples of suitable alkylene oxides are ethylene oxide, propylene oxide, 1,2-butylene oxide, 1,3-propylene oxide, 2,3-butylene oxide, styrene oxide, tetrahydrofuran or mixtures thereof, preferably ethylene oxide, propylene oxide, 1,2-butylene oxide, tetrahydrofuran or mixtures thereof, and more particularly tetrahydrofuran. The alkylene oxides may be used individually, alternately in succession or as mixtures.

Examples of useful starter molecules include: Water, aliphatic and aromatic, optionally N-mono-, N,N- and N,N′-dialkyl-substituted diamines having 1 to 4 carbon atoms in the alkyl radical, and more particularly polyhydric alcohols, such as ethanediol, 1,2- and 2,3-propanediol, diethylene glycol, dipropylene glycol, 1,4-butanediol, 1,6-hexanediol, glycerol, trimethylolpropane, pentaerythritol, and mixtures thereof. For the purposes of the present invention, the functionality of the polyetherol (b1) is regarded here as being the functionality of the starter molecule, although in reality the actual functionality of the polyetherpolyol may be lower as a result of secondary reactions. Fractional functionalities may be obtained through mixing of starter molecules having different functionality.

The polyetherol used may additionally be polytetrahydrofuran (poly-THF polyols). In this case, the number-average molecular weight of the polytetrahydrofuran is customarily 550 to 4000 g/mol, preferably 750 to 3000 g/mol, more preferably 800 to 2500 g/mol.

The polyether polyols may be used individually or in the form of mixtures.

The OH-terminated rubber (b2) used may be one or more OH-terminated rubbers; OH-terminated rubbers are understood to be all rubbers which comprise hydroxyl groups, for example nitrile rubbers comprising hydroxyl groups, as described for example in U.S. Pat. No. 3,551,472, and preferably hydroxyl-terminated polybutadienes (HTPB).

Liquid hydroxyl-terminated polybutadienes (HTPB) are long-established compounds and are employed as polyol components in polyurethanes. Commercial products may be obtained by radical polymerization (see U.S. Pat. No. 3,965,140) or ionic polymerization (see DD 160223) of 1,3-butadiene. Obtaining HTPB requires certain initiating and terminating reagents. Depending on the preparation process, polyols having different numbers of functional groups are obtained. The polybutadienols obtained by polymer-analogous reactions comprise differing amounts of reactive hydroxyl groups, depending on the degree of epoxidation and epoxide opening, and therefore have different functionalities. To improve the compatibility with polyetherols (b1) and isocyanates (a), the hydroxyl-terminated polybutadienes may also be modified with alkylene oxides or cyclic esters, such as ε-caprolactone. Such compounds are described for example in EP 3183282. Preference is given to using non-functionalized HTPBs.

Commercially available hydroxyl-terminated polybutadienes are, for example, the Poly bd® and Krasol® products from Cray Valley such as Krasol® LBH-P 2000 or Poly bd® R45V. Castor oil-based polyols are, for example, the Albodur® products from Alberdingk Boley, such as Albodur® 901, or the Polycine® products from Baker Castor Oil Company, such as Polycine®-GR80.

The OH functionality of the hydroxyl-terminated rubbers used is preferably in the range from 1.7 to 2.2 for anionically prepared grades or from 2.2 to 2.8 for radically prepared grades. If the epoxy group-terminated impact modifier is used in a 2K epoxy resin adhesive, it is preferred to use a hydroxyl-terminated rubber, more particularly a hydroxyl-terminated butadiene, having an OH functionality of less than or equal to 2. If the epoxy group-terminated impact modifier is used in a 1K epoxy resin adhesive, it is preferred to use a hydroxyl-terminated rubber, more particularly a hydroxyl-terminated butadiene, having an OH functionality in the range from 2.4 to 2.8. The stated preferred OH functionality for 2K and 1K epoxy resin adhesives may also be attained in the context of a mixture of two hydroxyl-terminated rubbers, more particularly hydroxyl-terminated polybutadienes.

The weight ratio of polyetherpolyol to hydroxyl-terminated rubber is preferably in the range from 7:3 to 2:8, very preferably 7:3 to 4:6, more preferably 7:3 to 5:5, more preferably still in the range from 6:4 to 2:8, and especially preferably 6:4 to 3:7. In this way, the mechanical properties of the cured adhesive can be improved, especially the impact peel resistance at −30° C.

Polyols chosen, more particularly polyols (b1) and (b2), are preferably those for which a mixture of polyol and a liquid epoxy resin prepared from bisphenol A and epichlorohydrin, such as Epikote 828 LVEL, in a weight ratio of 40 to 60 has a haze value measured according to ASTM D1003-11e1 in the range from 50 to 100 for hydroxy-terminated rubber (b2) as polyol and/or in the range from 0 to 5 for polyether polyol as polyol (b1).

The polyisocyanates (a) and the polyols (b) are then reacted to give the isocyanate-terminated prepolymer. For this reaction, the polyisocyanates (a) and the polyols (b) are mixed with one another in a proportion such that the molar ratio of isocyanate groups to OH groups is from 10:1 to 1.5:1, preferably 5:1 to 1.8:1, more preferably 3:1 to 1.9:1. The reaction takes place customarily at temperatures of 30 to 100° C., preferably at about 80° C., preferably in the presence of customary polyurethane catalysts. Such catalysts are described for example in “Kunststoffhandbuch”, volume 7, “Polyurethane”, Carl Hanser Verlag, 3rd edition 1993, chapter 3.4.1.

Examples of those contemplated are organometallic compounds, preferably organotin compounds, such as tin (II) salts of organic carboxylic acids, for example tin (II) acetate, tin (II) octoate, tin (II) ethylhexanoate and tin (II) laurate, and the dialkyltin (IV) salts of organic carboxylic acids, for example dibutyltin diacetate, dibutyltin dilaurate, dibutyltin maleate and dioctyltin diacetate, and also bismuth carboxylates, such as bismuth (III) neodecanoate, bismuth 2-ethylhexanoate and bismuth octanoate, or mixtures. Further possible catalysts are strongly basic amine catalysts. Examples of these include amidines such as 2,3-dimethyl-3,4,5,6-tetrahydropyrimidine, tertiary amines such as triethylamine, tributylamine, dimethylbenzylamine, N-methyl-, N-ethyl-, and N-cyclohexylmorpholine, N,N,N′,N′-tetramethylethylenediamine, N,N,N′,N′-tetra-methylbutanediamine, N,N,N′,N′-tetramethylhexanediamine, pentamethyldiethylenetriamine, tetramethyldiaminoethyl ether, bis(dimethylaminopropyl)urea, dimethylpiperazine, 1,2-dimethylimidazole, 1-azabicyclo[3.3.0]octane, and preferably 1,4-diazabicyclo[2.2.2]octane, and alkanolamine compounds such as triethanolamine, triisopropanolamine, N-methyl- and N-ethyldiethanolamine, and dimethylethanolamine. The catalysts may be used individually or as mixtures. With particular preference, metal catalysts exclusively are used for preparing the prepolymer.

The content of free isocyanate groups in the isocyanate prepolymer is customarily between 1% to 6% by weight of NCO, preferably 1.5% to 4% by weight of free NCO groups.

The isocyanate-terminated prepolymer is then reacted in a further step in the presence of ionic liquid with a polyepoxide (c) to give the epoxy group-terminated impact modifier. The reaction here takes place preferably at temperatures of 120 to 250° C.

The polyepoxide (c) used may be any desired aliphatic, cycloaliphatic, aromatic and/or heterocyclic compounds comprising at least two epoxy groups. The preferred epoxides suitable as component (c) have per molecule 2 to 4, preferably 2, epoxy groups and an epoxide equivalent weight of 90 to 500 g/eq, preferably 140 to 220 g/eq.

Suitable polyepoxides are, for example, polyglycidyl ethers of polyhydric phenols, for example of pyrocatechol, resorcinol, hydroquinone, 4,4′-dihydroxydiphenylpropane (bisphenol A), of 4,4′-dihydroxy-3,3′-dimethyldiphenylmethane, of 4,4′-dihydroxydiphenylmethane (bisphenol F), 4,4′-dihydroxydiphenylcyclohexane, of 4,4′-dihydroxy-3,3′-dimethyldiphenylpropane, of 4,4′-dihydroxydiphenyl, of 4,4′-dihydroxydiphenyl sulfone (bisphenol S), of tris(4-hydroxyphenyl)methane, the chlorination and bromination products of the aforementioned diphenols, of novolacs (i.e., of reaction products of mono- or polyhydric phenols and/or cresols with aldehydes, especially formaldehyde, in the presence of acidic catalysts in an equivalents ratio of less than 1:1), of diphenols that have been obtained by esterification of 2 mol of the sodium salt of an aromatic oxycarboxylic acid with one mole of a dihaloalkane or dihalodialkyl ester (cf. British patent 1 017 612), or of polyphenols that have been obtained by condensation of phenols and long-chain haloparaffins comprising at least two halogen atoms (cf. GB patent 1 024 288). The following may also be mentioned: polyepoxy compounds based on aromatic amines and epichlorohydrin, e.g. N-di(2,3-epoxypropyl)aniline, N,N′-dimethyl-N,N′-diepoxypropyl-4,4′-diaminodiphenylmethane, N,N-diepoxypropyl-4-amino-phenyl glycidyl ether (cf. GB patents 772 830 and 816 923).

The following are also useful: glycidyl esters of polyfunctional aromatic, aliphatic and cycloaliphatic carboxylic acids, for example diglycidyl phthalate, diglycidyl isophthalate, diglycidyl terephthalate, diglycidyl adipate and glycidyl esters of reaction products of 1 mol of an aromatic or cycloaliphatic dicarboxylic anhydride and ½ mol of a diol or 1/n mol of a polyol having n hydroxyl groups or diglycidyl hexahydrophthalate, which may optionally be substituted by methyl groups.

Glycidyl ethers of polyhydric alcohols, for example of butane-1,4-diol (Araldite® DY-D, Huntsman), butene-1,4-diol, glycerol, trimethylolpropane (Araldite® DY-T/CH, Huntsman), pentaerythritol and polyethylene glycol may likewise be used. Of further interest are triglycidyl isocyanurate, N,N′-diepoxypropyloxyamide, polyglycidyl thioethers of polyfunctional thiols, for example of bismercaptomethylbenzene, diglycidyltrimethylenetrisulfone, polyglycidyl ethers based on hydantoins.

Finally, it is also possible to use epoxidation products of polyunsaturated compounds, such as vegetable oils and conversion products thereof. Epoxidation products of di- and polyolefins, such as butadiene, vinylcyclohexane, 1,5-cyclooctadiene, 1,5,9-cyclododecatriene, polymers and copolymers still comprising epoxidizable double bonds, for example based on polybutadiene, polyisoprene, butadiene-styrene copolymers, divinylbenzene, dicyclopentadiene, unsaturated polyesters, and also epoxidation products of olefins that are obtainable by Diels-Alder addition and then converted by epoxidation with per compound to polyepoxides, or of compounds comprising two cyclopentene or cyclohexene rings bound via bridgehead atoms or bridgehead atom groups, may likewise be used.

In addition, it is also possible to use polymers of unsaturated monoepoxides, for example of glycidyl methacrylate or allyl glycidyl ether.

Preference is given in accordance with the invention to using the following polyepoxy compounds or mixtures thereof as component (c):

polyglycidyl ethers of polyhydric phenols, especially of bisphenol A (Araldit® GY250, Huntsman; Ruetapox® 0162, Bakelite AG; Epikote® Resin 162, Hexion Specialty Chemicals GmbH; Eurepox 710, Brenntag GmbH; Araldit® GY250, Hunstman, D.E.R.™ 332, The Dow Chemical Company; Epilox® A 18-00, LEUNA-Harze GmbH) or Bisphenol F (4,4′-dihydroxydiphenylmethane, Araldit® GY281, Huntsman; Epilox® F 16-01, LEUNA-Harze GmbH; Epilox® F 17-00, LEUNA-Harze GmbH), polyepoxy compounds based on aromatic amines, especially bis(N-epoxypropyl)aniline, N,N′-dimethyl-N,N′-diepoxypropyl-4,4′-diaminodiphenylmethane and N,N-diepoxypropyl-4-aminophenyl glycidyl ether; polyglycidyl esters of cycloaliphatic dicarboxylic acids, especially diglycidyl hexahydrophthalate and polyepoxides formed from the reaction product of n moles of hexahydrophthalic anhydride and 1 mol of a polyol having n hydroxyl groups (n=integer of 2-6), especially 3 mol of hexahydrophthalic anhydride and one mole of 1,1,1-trimethylolpropane; 3,4-epoxycyclohexylmethane 3,4-epoxycyclohexanecarboxylate.

Polyglycidyl ethers of bisphenol A and bisphenol F and of novolacs and mixtures thereof are very particularly preferred, especially polyglycidyl ethers of bisphenol F.

Liquid polyepoxides or low-viscosity diepoxides, such as bis (N-epoxypropyl) aniline or vinylcyclohexane diepoxide, may in particular cases further lower the viscosity of already liquid polyepoxides or convert solid polyepoxides to liquid mixtures. The polyepoxides (c) preferably comprise a minimal content of byproducts comprising OH groups, such as glycols. The fraction of byproducts comprising OH groups here is reported in OH numbers of the polyepoxide (c). The OH number of the polyepoxides (c) is with particular preference less than 20 mg KOH/g, with particular preference less than 10 mg KOH/g.

Ionic liquids are widely known, frequently described, and commercially available. For example, ionic liquids suitable for improving the conductivity of polyurethanes are thus described in EP 2038337. Ionic liquids in this context are salts of the general formula (I)

$${{[ A ]}_{n}^{+} [ Y ]}^{n -} , \qquad ( I )$$

in which n is 1, 2, 3 or 4, [A]⁺ is a quaternary ammonium cation, an oxonium cation, a sulfonium cation or a phosphonium cation and [Y]ⁿ⁻ is a monovalent, divalent, trivalent or tetravalent anion;

(B) mixed salts of the general formulae (II)

$${{{[ {A}^{1} ]}^{+} [ {A}^{2} ]}^{+} [ Y ]}^{n -} , where n = 2 ; \qquad ( IIa )$$

$${{{{[ {A}^{1} ]}^{+} [ {A}^{2} ]}^{+} [ {A}^{3} ]}^{+} [ Y ]}^{n -} , where n = 3 ; or \qquad ( IIb )$$

$${{{{{[ {A}^{1} ]}^{+} [ {A}^{2} ]}^{+} [ {A}^{3} ]}^{+} [ {A}^{4} ]}^{+} [ Y ]}^{n -} , where n = 4 \qquad ( IIc )$$

and

where [A¹]⁺, [A²]⁺, [A³]⁺ and [A⁴]⁺ independently of one another are selected from the groups stated for [A]⁺ and [Y]ⁿ⁻ has the meaning stated under (A); or

(C) mixed salts of the general formulae (III)

$${{{{{[ {A}^{1} ]}^{+} [ {A}^{2} ]}^{+} [ {A}^{3} ]}^{+} [ {M}^{1} ]}^{+} [ Y ]}^{n -} , where n = 4 ; \qquad ( IIIa )$$

$${{{{{[ {A}^{1} ]}^{+} [ {A}^{2} ]}^{+} [ {M}^{1} ]}^{+} [ {M}^{2} ]}^{+} [ Y ]}^{n -} , where n = 4 ; \qquad ( IIIb )$$

$${{{{{[ {A}^{1} ]}^{+} [ {M}^{1} ]}^{+} [ {M}^{2} ]}^{+} [ {M}^{3} ]}^{+} [ Y ]}^{n -} , where n = 4 ; \qquad ( IIIc )$$

$${{{{[ {A}^{1} ]}^{+} [ {A}^{2} ]}^{+} [ {M}^{1} ]}^{+} [ Y ]}^{n -} , where n = 3 ; \qquad ( IIId )$$

$${{{{[ {A}^{1} ]}^{+} [ {M}^{1} ]}^{+} [ {M}^{2} ]}^{+} [ Y ]}^{n -} , where n = 3 ; \qquad ( IIIe )$$

$${{{[ {A}^{1} ]}^{+} [ {M}^{1} ]}^{+} [ Y ]}^{n -} , where n = 2 ; \qquad ( IIIf )$$

$${{{{[ {A}^{1} ]}^{+} [ {A}^{2} ]}^{+} [ {M}^{4} ]}^{2 +} [ Y ]}^{n -} , where n = 4 ; \qquad ( IIIg )$$

$${{{{[ {A}^{1} ]}^{+} [ {M}^{1} ]}^{+} [ {M}^{4} ]}^{2 +} [ Y ]}^{n -} , where n = 4 ; \qquad ( IIIh )$$

$${{{[ {A}^{1} ]}^{+} [ {M}^{5} ]}^{3 +} [ Y ]}^{n -} , where n = 4 ; or \qquad ( IIIi )$$

$${{{[ {A}^{1} ]}^{+} [ {M}^{4} ]}^{2 +} [ Y ]}^{n -} , where n = 3 \qquad ( IIIj )$$

and

where [A¹]⁺, [A²]⁺ and [A³]⁺ independently of one another are selected from the groups stated for [A]⁺, [Y]ⁿ⁻ has the meaning stated under (A) and [M¹]⁺, [M²]⁺, [M³]⁺ are monovalent metal cations, [M⁴]²⁺ are divalent metal cations and [M⁵]³⁺ are trivalent metal cations.

The ionic liquids used in the context of the present invention possess a melting point in a range from −50° C. to 150° C., more preferably in the range from −20° C. to below 100° C. and additionally more preferably from −20° C. to below 80° C. With particular preference, the melting point of the ionic liquid is below 50° C.; more particularly, ionic liquids of the invention are liquid at room temperature. Ionic liquids liquid at room temperature are easy to process and have an excellent antistatic effect.

Compounds suitable for forming the cation [A]⁺ of ionic liquids are known for example from DE 102 02 838 A1. Such compounds may thus comprise oxygen, phosphorus, sulfur or especially nitrogen atoms, for example at least one nitrogen atom, preferably 1-10 nitrogen atoms, particularly preferably 1-5, very particularly preferably 1-3 and especially 1-2 nitrogen atoms. Further heteroatoms such as oxygen, sulfur or phosphorus atoms can also optionally be present. The nitrogen atom is a suitable carrier of the positive charge in the cation of the ionic liquid, from which a proton or an alkyl radical can then migrate in equilibrium to the anion to produce an electrically neutral molecule. The positive charge may also be delocalized in a mesomeric system.

If the nitrogen atom is the carrier of the positive charge in the cation of the ionic liquid, a cation can firstly be produced by quaternization of the nitrogen atom of, for instance, an amine or nitrogen heterocycle in the synthesis of the ionic liquids. Quaternization can be effected by alkylation of the nitrogen atom. Depending on the alkylating reagent used, salts having different anions are obtained. In cases in which it is not possible to form the desired anion in the quaternization alone, this can be carried out in a further synthesis step. Starting from, for example, an ammonium halide, the halide can be reacted with a Lewis acid to form a complex anion from halide and Lewis acid. As an alternative, replacement of a halide ion by the desired anion is possible. This can be effected by addition of a metal salt with precipitation of the metal halide formed, by means of an ion exchanger or by displacement of the halide ion by a strong acid (with liberation of the hydrohalic acid). Suitable processes are described for example in Angew. Chem. 2000, 112, pp 3926-3945 and the literature cited therein.

As anions, it is in principle possible to use all anions. Anions preferably employable are described for example in EP 2038337.

Ionic liquids used in the sense of the invention are preferably substances having a soft cation and/or a soft anion. This means that cations and/or anions are well-stabilized, by inductive and/or mesomeric effects, for example. Cations here preferably have electron-donating substituents. The cation preferably comprises exclusively electron-donating substituents. The anions preferably have electron-withdrawing substituents. Particular preference here is given to using an ionic liquid for which the charge of the cation, of the anion, or of the cation and the anion is delocalized by mesomeric effects. Preferred cations are therefore imidazolium, guanidinium or pyrazolium derivatives, more particularly imidazolium derivatives. With particular preference, ionic liquids of the invention have cations selected from the group comprising 1,2,3-trimethylimidazolium, 1,3,4,5-tetramethylimidazolium, 1,3,4-dimethylimidazolium, 1,3,4-trimethylimidazolium, 1,3-dibutyl-2-methylimidazolium, 1,3-dibutylimidazolium, 1,2-dimethylimidazolium, 1,3-dimethylimidazolium, 1-benzyl-3-methylimidazolium, 1-butyl-2,3-dimethylimidazolium, 1-butyl-2-ethyl-5-methylimidazolium, 1-butyl-2-ethylimidazolium, 1-butyl-2-methylimidazolium, 1-butyl-3,4,5-trimethylimidazolium, 1-butyl-3,4-dimethylimidazolium, 1-butyl-3-ethylimidazolium, 1-butyl-3-methylimidazolium, 1-butyl-4-methylimidazolium, 1-butylimidazolium, 1-decyl-3-methylimidazolium, 1-dodecyl-3-methylimidazolium, 1-ethyl-2,3-dimethylimidazolium, 1-ethyl-3-methylimidazolium, 1-hexadecyl-2,3-dimethylimidazolium, 1-hexadecyl-3-methylimidazolium, 1-hexyl-2,3-dimethylimidazolium, 1-hexyl-3-methylimidazolium, 1-methyl-2-ethylimidazolium, 1-methyl-3-octylimidazolium, 1-methylimidazolium, 1-pentyl-3-methylimidazolium, 1-phenylpropyl-3-methylimidazolium, 1-propyl-2,3-dimethylimidazolium, 1-tetradecyl-3-methylimidazolium, 2,3-dimethylimidazolium, 2-ethyl-3,4-dimethylimidazolium, 3,4-dimethylimidazolium, 1,2-dimethylpyridinium, guanidinium, hexamethylguanidinium, N,N,N′,N′-tetramethyl-N″-ethylguanidinium, N-pentamethyl-N-isopropylguanidinium, N-pentamethyl-N-propylguanidinium, benzyltriphenylphosphonium, tetrabutylphosphonium, trihexyl(tetradecyl)phosphonium and triisobutyl(methyl)phosphonium. The anions for the process of the invention are preferably selected from the group comprising acetate, bis(2,4,4-trimethylpentyl)phosphinate, bis(malonato)borate, bis(oxalato)borate, bis(pentafluoroethyl)phosphinate, bis(phtalato)borate, bis(salicylato)borate, bis(trifluoromethansulfonyl)imidate, bis(trifluoromethyl)imidate, borate, bromide, bromoaluminates, carbonate, chloroaluminates, decylbenzolsulfonate, dichlorocuprate, dicyanamide, didecylbenzenesulfonate, didodecylbenzenesulfonate, diethylphosphate, dihydrogenphosphate, dodecylbenzenesulfonate, ethylsulfate, ethylsulfonate, fluoride, hexafluorophosphate, hydrogencarbonate, hydrogenphosphate, hydrogensulfate, hydrogensulfite, iodide, methylsulfate, methylsulfonate, nitrate, nitrite, phosphate, sulfite, tetracyanoborate, tetrafluoroborate, tetrakis(hydrogensulfato)borate, tetrakis(methylsulfonato)borate, thiocyanate, tosylate, trichlorozincate, trifluoroacetate, trifluoromethylsulfonate, tris(heptafluoropropyl)trifluorophosphate, tris(nonafluorobutyl)trifluorophosphate, tris(pentafluoroethyl)trifluorophosphate, tris(pentafluoroethylsulfonyl)trifluorophosphate.

Particularly preferred anions are hexafluorophosphate, tetrafluoroborate, thiocyanate and dicyanamide, ethylsulfate, diethylphosphate, methylsulfate, bromide, iodide, p-toluenesulfonate and methanesulfonate, more particularly on the basis of ethylsulfate, thiocyanate, bromide or dicyanamide, very preferably bromide.

Preferred ionic liquids used in the sense of the invention are 1-ethyl-3-methylimidazolium chloride, 1-butyl-3-methylimidazolium chloride, 1-ethyl-3-methylimidazolium methylsulfonate, 1-butyl-3-methylimidazolium methanesulfonate, 1-ethyl-3-methylimidazolium ethylsulfate, 1-butyl-3-methylimidazolium methylsulfate, 1-ethyl-3-methylimidazolium diethylphosphate, 1-butyl-3-methylimidazolium dimethylphosphate, 1-ethyl-3-methylimidazolium dicyanamide, 1-butyl-3-methylimidazolium dicyanamide, 1-ethyl-3-methylimidazolium acetate, 1-butyl-3-methylimidazolium acetate, 1-ethyl-3-methylimidazolium thiocyanate, 1-butyl-3-methylimidazolium thiocyanate, 1-ethyl-3-methylimidazolium tetrafluoroborate, 1-butyl-3-methylimidazolium tetrafluoroborate, 1-ethyl-3-methylimidazolium trifluoromethanesulfonate, 1-butyl-3-methylimidazolium trifluoromethanesulfonate, 1-ethyl-3-methylimidazolium bis(trifluoromethanesulfonyl)imide, 1-butyl-3-methylimidazolium bis(trifluoromethanesulfonyl)imide, 1-ethyl-3-methylimidazolium hexafluorophosphate, 1-butyl-3-methylimidazolium hexafluorophosphate, 1-ethyl-3-methylimidazolium bromide, 1-butyl-3-methylimidazolium bromide, 1-ethyl-3-methylimidazolium p-toluenesulfonate and/or 1-butyl-3-methylimidazolium p-toluenesulfonate.

With particular preference, the ionic liquid in the sense of the invention is selected from the group consisting of 1-ethyl-3-methylimidazolium methylsulfonate, 1-ethyl-3-methylimidazolium ethylsulfate, 1-ethyl-3-methylimidazolium dicyanamide, 1-ethyl-3-methylimidazolium thiocyanate, 1-ethyl-3-methylimidazolium tetrafluoroborate, 1-ethyl-3-methylimidazolium bromide, 1-butyl-3-methylimidazolium bromide, 1-butyl-3-methylimidazolium bromide and mixtures of at least two members of this group used. Employed in particular as ionic liquid is 1-butyl-3-methylimidazolium bromide.

The ionic liquid is present in the antistatic or conductive polyurethane of the invention preferably in an amount of 0.001 to 2 percent by weight, more preferably of 0.01 to 1.5 percent by weight, more preferably still of 0.05 to 1.0 percent by weight, very preferably of 0.05 to 0.5 percent by weight, based in each case on the total weight of the isocyanate-terminated prepolymer and of the polyepoxide (c). The ionic liquids used may be employed here individually or in the form of mixtures.

The reaction of the isocyanate-terminated prepolymer with a polyepoxide (c) in the presence of an ionic liquid to give the epoxy group-terminated impact modifier here may take place partially or completely; in the case of a complete reaction, substantially all of the isocyanate groups of the prepolymer are reacted with epoxy groups, and in the case of a partial reaction, isocyanate groups still remain. The fraction of unreacted isocyanate groups in the impact modifier of the invention preferably is less than 1% by weight, preferably less than 0.1% by weight and more particularly less than 0.01% by weight, based on the total weight of the epoxy group-terminated impact modifier. In one particularly preferred embodiment, the epoxy group-terminated impact modifier comprises no isocyanate groups.

The epoxy group-terminated impact modifier preparable by a process of the invention may be added to a one-component or two-component epoxy resin composition, preferably in a one-component or two-component epoxy resin adhesive, for increasing the impact resistance of the cured epoxy resin matrix. A further field of use of the epoxy group-terminated impact modifier of the invention is the deployment in epoxy-containing polyurethanes and polyisocyanurates. Such compounds are described for example in WO 2015078740.

The epoxy group-terminated impact modifier of the invention is preferably deployed by adding it to one of the liquid starting components of the epoxy resin composition; alternatively, the impact modifier may also be added as an independent component of the epoxy resin composition. The fraction of the impact modifier of the invention here is preferably 1% to 75%, more preferably 10% to 60% and more particularly 25% to 55% by weight, based on the total weight of the epoxy resin composition. The epoxy resin composition of the invention that is obtained exhibits improved impact strength, at least equal tensile strength, and reduced crack propagation. Relative to an epoxy resin composition without impact modifier, the effect on the glass transition temperature here is no more than insubstantial, meaning that with use of 20% by weight of impact modifier, based on the total weight of epoxy resin composition and impact modifier, the glass transition temperature falls preferably by less than 20° C., more preferably by less than 10° C. and more particularly by less than 5° C., relative to the epoxy resin composition without impact modifier. Further, the viscosity of the epoxy resin composition of the invention, comprising 20% by weight of impact modifier, at 40° C. rises preferably by less than 50% of the initial value without impact modifier, more preferably by less than 30% and more particularly by less than 10%.

The invention shall be elucidated hereinbelow with reference to examples.

Description of the determination of oxirane groups (EEW determination):

To characterize the oxirane group (“epoxy group”) content of compounds, an epoxide titration was carried out. The epoxide number obtained here (% EpO) indicates how many grams of oxirane oxygen are present in 100 grams of a sample.

Crystal violet is used as indicator. The determination requires the absence of water, bases and amines.

Reagents:

(1) 0.1 N Perchloric acid (Merck) in glacial acetic acid

(2) Tetraethylammonium bromide (Fluka) in the form of a solution of 100 g of tetraethylammonium bromide in 400 ml of glacial acetic acid

(3) Crystal violet (Merck); the indicator solution was prepared by dissolving 0.2 g of crystal violet in 100 mL of glacial acetic acid

Procedure:

0.2 to 0.5 g of the sample comprising oxirane rings is placed in a conical flask. The sample is dissolved in 50 ml of anhydrous acetone. Then 10 ml of tetraethylammonium bromide solution and 3 drops of crystal violet solution are added. The mixture is titrated with a 0.1 N solution of perchloric acid in glacial acetic acid. The end point is reached as soon as the color changes from blue to green. Before the titration proper is carried out, a blank sample is performed (comprising no oxirane compound) in order to rule out measurement errors.

Evaluation:

The epoxy content % EpO is calculated as follows: % EpO=[(a−b)+0.160]/I

$$a := consumption in ml of 0.1 N perchloric acid for titration$$

$$b := consumption in ml of 0.1 N perchloric acid for blank sample$$

$$l := initial mass of sample in grams$$

The epoxide equivalent weight (EEW) is calculated according to the following formula:

$$EE W = 1600 / \% Ep O$$

The units of EEW are g/eq.

The NCO content was determined in % by weight by back-titration of the corresponding samples with excess di-n-butylamine 1 M in chlorobenzene with 1-molar hydrochloric acid.

Tensile strength, elasticity modulus and elongation at break from tensile testing according to DIN EN ISO 527 with a test speed of 20 mm/min.

Charpy impact resistance according to DIN EN ISO 179-1/1fU.

Fracture toughness K_{1C} and fracture energy G_{1C} by OCT (optical crack tracing) in accordance with ISO 13586 and ASTM D5045, measured at Fraunhofer IAP-PYCO.

The starting materials used for preparing the epoxy resins were as follows:

| Name | Description | Company |
|---|---|---|
| D.E.R. ® 330 | Bisphenol A epoxy resin | Dow |
| EMIM-Br | 1-Ethyl-3-methylimidazolium | Iolitec |
| | bromide; CAS No. 65039- | |
| | 08-9; | |
| | Catalyst | |
| Vestanat ® IPDI | Isophorone diisocyanate | Evonik |
| | NCO: 37.60% | |
| PolyTHF ® 2000 | Polyol (difunctional poly- | BASF |
| | butylene glycol with a molar | |
| | mass of 2000 g/mol) | |
| | OH number: 57.0 mg/g KOH | |
| Polyvest ® EP HT | Polyol (hydroxyl-terminated | Evonik |
| | polybutadiene with a molar | |
| | mass of 2900 g/mol) | |
| | OH number: 47.5 mg/g KOH | |
| Krasol ® LBH-P 2000 | Polyol (hydroxyl-terminated | Cray Valley |
| | polybutadiene with a molar | |
| | mass of 2000 g/mol) | |
| | OH number: 53.7 mg/g KOH | |
| Cardolite ® NX 2026 | Cardanol | Cardolite |
| Fomrez ® UL 28 | Tin catalyst | Galata Chemicals |
| Lupranat ® T80 A | TDI | BASF |
| | NCO: 48.20% | |
| Epikote ® 828 | Bisphenol A epoxy resin | Hexion |
| Lupranol ® 1000/1 | Polyol (polypropylene glycol) | BASF |
| | OH number: 55.0 mg/g KOH | |
| Epikote ® 828 LVEL | Bisphenol A epoxy resin | Hexion |
| Araldite ® GT 6071 | Bisphenol A epoxy resin | Huntsman |
| Dyhard ® 100 SF | Catalyst | AlzChem |
| Dyhard ® UR 700 | Catalyst | AlzChem |
| Omyacarb ® 5 GU | Calcium carbonate | Omya |
| HDK ® H18 | Fumed silica | Wacker |
| Precal 30 S | Calcium oxide | Schaefer Kalk |

### Example 1: NCO-Terminated Prepolymer 1

416.61 g of PolyTHF 2000 and 416.61 g of Polyvest EP HT were dried at 90° C. with stirring for 1 hour under reduced pressure. Then 0.14 g of Fomrez UL 28 was added, with stirring for 5 minutes. 166.64 g of Vestanat IPDI were added and the reaction was carried out for 2 hours under reduced pressure at 90° C. This gave a product having a free NCO content of 3.08% (theoretical NCO content: 3.00%).

### Example 2: NCO-Terminated Prepolymer 2

498.71 g of PolyTHF 2000 and 332.47 g of Polyvest EP HT were dried at 90° C. with stirring for 1 hour under reduced pressure. Then 0.08 g of Fomrez UL 28 was added, with stirring for 5 minutes. 168.73 g of Vestanat IPDI were added and the reaction was carried out for 2 hours under reduced pressure at 90° C. This gave a product having a free NCO content of 3.15% (theoretical NCO content: 3.00%).

### Example 3: NCO-Terminated Prepolymer 3

495.82 g of PolyTHF 2000 and 330.54 g of Krasol LBH-P 2000 were dried at 90° C. with stirring for 1 hour under reduced pressure. Then 0.10 g of Fomrez UL 28 was added, with stirring for 5 minutes. 173.54 g of Vestanat IPDI were added and the reaction was carried out for 2 hours under reduced pressure at 90° C. This gave a product having a free NCO content of 3.03% (theoretical NCO content: 3.00%).

### Example 4

A 1 L four-neck round-bottom flask, fitted with KPG stirrer, thermal sensor, dropping funnel (heatable to 80° C.) and condenser, with N2 purging via condenser, was charged with 440 g of D.E.R. 330 and 0.46 g of EMIM-Br and heated with N2 purging to 160° C. Via the dropping funnel, 220 g (0.0770 equivalents of NCO) of the NCO-terminated prepolymer 1 from example 1 were added dropwise over the course of 2 hours, during which the reaction temperature was held constant at 160-170° C. When addition was complete, stirring was continued for 30 min at reaction temperature and a sample was taken for IR spectroscopy. Complete reaction of the isocyanate was verified by the disappearance of the band at 2270 cm⁻¹ (NCO vibration). The reaction mixture was cooled to around 100° C. and dispensed. This gave a viscous product having an EEW of 308.5 and a viscosity of 4250 mPas (measured at 80° C.).

### Example 5

A 1 L four-neck round-bottom flask, fitted with KPG stirrer, thermal sensor, dropping funnel (heatable to 80° C.) and condenser, with N2 purging via condenser, was charged with 440 g of D.E.R. 330 and 0.46 g of EMIM-Br and heated with N2 purging to 160° C. Via the dropping funnel, 220 g (0.0770 equivalents of NCO) of the NCO-terminated prepolymer 2 from example 2 were added dropwise over the course of 2 hours, during which the reaction temperature was held constant at 160-170° C. When addition was complete, stirring was continued for 30 min at reaction temperature and a sample was taken for IR spectroscopy. Complete reaction of the isocyanate was verified by the disappearance of the band at 2270 cm⁻¹ (NCO vibration). The reaction mixture was cooled to around 100° C. and dispensed. This gave a viscous product having an EEW of 286.9 and a viscosity of 3340 mPas (measured at 80° C.).

### Example 6

A 1 L four-neck round-bottom flask, fitted with KPG stirrer, thermal sensor, dropping funnel (heatable to 80° C.) and condenser, with N2 purging via condenser, was charged with 440 g of D.E.R. 330 and 0.46 g of EMIM-Br and heated with N2 purging to 160° C. Via the dropping funnel, 220 g (0.0770 equivalents of NCO) of the NCO-terminated prepolymer 3 from example 3 were added dropwise over the course of 2 hours, during which the reaction temperature was held constant at 160-170° C. When addition was complete, stirring was continued for 30 min at reaction temperature and a sample was taken for IR spectroscopy. Complete reaction of the isocyanate was verified by the disappearance of the band at 2270 cm⁻¹ (NCO vibration). The reaction mixture was cooled to around 100° C. and dispensed. This gave a viscous product having an EEW of 297.0 and a viscosity of 4018 mPas (measured at 80° C.).

### Comparative Example 1: Phenol-Blocked Prepolymer

254.44 g of PolyTHF 2000 and 254.44 g of Polyvest EP HT were dried at 90° C. with stirring for 1 hour under reduced pressure. Then 0.08 g of Fomrez UL 28 was added, with stirring for 5 minutes. 102.62 g of Vestanat IPDI were added and the reaction was carried out for 2 hours under reduced pressure at 90° C. A sample was taken and a free NCO content of 3.05% (theoretical NCO content: 3.00%) was determined. 138.24 g of Cardolite NX 2026 and 0.17 g of Fomrez UL 28 were added and the reaction was carried out for 2 hours at 110° C. under reduced pressure. The reaction of the NCO-terminated prepolymer was verified by measurement of the NCO content (<0.3%).

### Comparative Example 2: Impact Modifier According to U.S. Pat. No. 5,480,958

123.58 g of Lupranat T 80 A and 676.42 g of Lupranol 1000/1 were mixed and heated under nitrogen to 80° C. The reaction was carried out for 9 h at 90° C. A prepolymer having a free NCO content of 3.74% (theoretical NCO content 3.80%) was obtained. 197.29 g of the prepolymer obtained were mixed with 452.57 g of Epikote 828 and 0.13 g of potassium acetate and heated to 160° C. After an hour at 160° C., a sample was taken and the reaction of the prepolymer was verified by measurement of the NCO content (0.01%). This gave a viscous product having an EEW of 280.6.

Following examples illustrate the use of the impact modifiers described, in 1-component, heat-curing adhesives.

For the preparation, in the corresponding proportions in the table, Epikote 828 LVEL, the corresponding impact modifier, Precal 30 S and Omyacarb 5 GU were charged to a planetary mixer and heated to 80° C. After the mixing of the solids, Araldite GT 6071 was added and the mixture was cooled to 60° C. This was followed by addition of HDK H18 and also Dyhard 100SF and Dyhard UR700 and the mixture was stirred in the planetary mixer for 1 hour.

The adhesives were cured at 175° C. for 30 minutes.

| | | | | Comparative | Comparative | Comparative |
|---|---|---|---|---|---|---|
| Figures in % by weight | Example 7 | Example 8 | Example 9 | example 3 | example 4 | example 5 |
| Epikote Resin 828 LVEL | 12.70 | 19.00 | 12.70 | 9.40 | 15.80 | 35.00 |
| Araldite GT 6071 | 12.00 | 18.00 | 12.00 | 12.00 | 20.10 | 12.00 |
| Impact modifier | 47.30 | 35.00 | | | | |
| from example 4 | | | | | | |
| Impact modifier | | | 47.30 | | | |
| from example 5 | | | | | | |
| Impact modifier from | | | | | | 25.00 |
| comparative example 1 | | | | | | |
| Impact modifier from | | | | 50.60 | 37.50 | |
| comparative example 2 | | | | | | |
| Omyacarb 5 GU | 20.96 | 20.96 | 20.96 | 20.96 | 20.96 | 20.96 |
| Precal 30 S | 5.00 | 5.00 | 5.00 | 5.00 | 5.00 | 5.00 |
| HDK H18 | 4.00 | 4.00 | 4.00 | 4.00 | 4.00 | 4.00 |
| Dyhard 100SF | 3.96 | 4.03 | 3.96 | 3.86 | 3.97 | 3.15 |
| Dyhard UR700 | 0.21 | 0.21 | 0.21 | 0.20 | 0.21 | 0.17 |
| Curing: 30 min, 175° C. | | | | | | |
| Mechanics | | | | | | |
| Tensile strength [MPa] | 38.5 ± 2.3 | 41.8 ± 3.8 | 35.9 ± 2.6 | 42.1 ± 2.4 | 41.7 ± 1.1 | 31.7 ± 2.3 |
| Elongation at break [%] | 5 ± 2 | 6 ± 4 | 4 ± 2 | 3 ± 1 | 2 ± 0 | 4 ± 2 |
| Elasticity modulus [MPa] | 2744 ± 528 | 2306 ± 2 | 2667 ± 194 | 2855 ± 122 | 3285 ± 119 | 1834 ± 239 |
| Impact resistance [kJ/m²] | 29.1 ± 8.1 | 27.8 ± 9.0 | 22.6 ± 2.6 | 13.0 ± 2.6 | 16.2 ± 4.1 | 24.5 ± 6.8 |
| K_{1C} [MN/M^{3/2}] | 2.9 ± 0.4 | 2.9 ± 0.2 | 2.5 ± 0.2 | 1.6 ± 0.1 | 2.0 ± 0.1 | 2.2 ± 0.1 |
| G_{1C} [J/m²] | 3300 | 3500 | 4100 | 800 | 900 | |
| DMA | | | | | | |
| TG(max G″) [° C.] | 120 | 120 | 120 | 125 | 130 | 70 |

The comparison of example 7 with comparative example 3 (comprising the same amount of impact modifier) and the comparison of example 8 with comparative example 4 (comprising the same amount of impact modifier) illustrate that the impact modifiers described in the Notification of invention in both cases exhibit significantly better performance than the impact modifier according to U.S. Pat. No. 5,480,958. Not only the impact resistance but also K1C and G1C show significantly higher values.

A comparison of examples 7, 8 and 9 with comparative example 5, representing the prior art as a phenol-blocked impact modifier, shows the advantages of the impact modifiers described in this Notification of invention. The epoxy-terminated prepolymers described here permit direct reaction with the epoxy matrix in the adhesive formulation. The phenol-blocked prepolymers have to deblock first at the curing temperature before they can react with the epoxy matrix. Not only the Tg but also the elasticity modulus of examples 7, 8 and 9 are significantly higher than comparative example 5.

1. A process for preparing an epoxy group-terminated impact modifier, comprising mixing:
a) one or more polyisocyanates with
b) two or more polyols, comprising at least one polyetherpolyol (b1) and at least one OH-terminated rubber (b2),
at a molar ratio of isocyanate groups to OH groups of 10:1 to 1.5:1 to form a mixture and reacting the mixture to give an isocyanate-terminated prepolymer, and
c) reacting the isocyanate-terminated prepolymer with a polyepoxide (c) in the presence of an ionic liquid to give the epoxy group-terminated impact modifier.

2. The process according to claim 1, wherein said one or more polyisocyanates comprises an aliphatic polyisocyanate.

3. The process according to claim 1, wherein the at least one OH-terminated rubber (b2) comprises a hydroxyl-terminated polybutadiene.

4. The process according to claim 1, wherein the at least one OH-terminated rubber (b2) has an OH functionality in the range from 1.7 to 2.8.

5. The process according to claim 1, wherein the the at least one polyetherpolyol (b1) comprises the alkoxylation product of a di- to trifunctional starter molecule, the alkylene oxide being selected from the group consisting of ethylene oxide, propylene oxide, 1,2-butylene oxide, tetrahydrofuran and mixtures thereof.

6. The process according to claim 1, wherein the at least one polyetherpolyol (b1) is comprises polytetrahydrofuran.

7. The process according to claim 1, wherein the at least one polyetherpolyol (b1) has an OH number of 20 to 100 mg KOH/g.

8. The process according to claim 1, wherein the polyepoxide is selected from the group consisting of polyglycidyl ethers of bisphenol A, bisphenol F, novolacs and mixtures thereof.

9. The process according claim 1, wherein the ionic liquid is selected from the group consisting of 1-ethyl-3-methylimidazolium chloride, 1-butyl-3-methylimidazolium chloride, 1-ethyl-3-methylimidazolium methylsulfonate, 1-butyl-3-methylimidazolium methanesulfonate, 1-ethyl-3-methylimidazolium ethylsulfate, 1-butyl-3-methylimidazolium methylsulfate, 1-ethyl-3-methylimidazolium diethylphosphate, 1-butyl-3-methylimidazolium dimethylphosphate, 1-ethyl-3-methylimidazolium dicyanamide, 1-butyl-3-methylimidazolium dicyanamide, 1-ethyl-3-methylimidazolium acetate, 1-butyl-3-methylimidazolium acetate, 1-ethyl-3-methylimidazolium thiocyanate, 1-butyl-3-methylimidazolium thiocyanate, 1-ethyl-3-methylimidazolium tetrafluoroborate, 1-butyl-3-methylimidazolium tetrafluoroborate, 1-ethyl-3-methylimidazolium trifluoromethanesulfonate, 1-butyl-3-methylimidazolium trifluoromethanesulfonate, 1-ethyl-3-methylimidazolium bis(trifluoromethanesulfonyl)imide, 1-butyl-3-methylimidazolium bis(trifluoromethanesulfonyl)imide, 1-ethyl-3-methylimidazolium hexafluorophosphate, 1-butyl-3-methylimidazolium hexafluorophosphate, 1-ethyl-3-methylimidazolium bromide, 1-butyl-3-methylimidazolium bromide, 1-ethyl-3-methylimidazolium p-toluenesulfonate and 1-butyl-3-methylimidazolium p-toluenesulfonate.

10. The process according to claim 9, wherein the ionic liquid comprises 1-ethyl-3-methylimidazolium bromide.

11. The process according to claim 1, wherein the reaction of the isocyanate-terminated prepolymer to give the epoxy group-terminated impact modifier is carried out at a temperature of 120 to 250° C.

12. An epoxy group-terminated impact modifier, obtained according to the process of claim 1.

13. A one-component or two-component epoxy resin adhesive, comprising the epoxy group-terminated impact modifier according to claim 12.

14. A one-component or two-component epoxy resin composition, comprising at least one epoxy group-terminated impact modifier according to claim 12.
